(19) United States
(12) Patent Application Publication
(10) Pub. No.: US 2009/0314775 A1
(43) Pub. Date: Dec. 24, 2009

(54) LABEL WITH A SECURITY FEATURE AND CONTAINER WITH A LABEL

(75) Inventors: Christoph Dietrich, Heidelberg (DE); Christoph Jürgens, Hamburg (DE); Stefan Stadler, Hasloh (DE)

Correspondence Address: NORRIS, MCLAUGHLIN & MARCUS, 875 THIRD AVE, 18TH FLOOR, NEW YORK, NY, 10022, US

(73) Assignee: Tesa Scribos GmbH, Heidelberg (DE)

(21) Appl. No.: 12/301,928

(22) PCT Filed: May 25, 2007
(86) PCT No.: PCT/EP2007/004665

§ 371 Date: Jan. 23, 2009

(30) Foreign Application Priority Data
May 31, 2006 (DE) 10 2006 025 335.3

(51) Int. Cl. B65D 51/24; B42D 15/00

(52) U.S. Cl. 220/212; 283/81

(57) ABSTRACT

The invention relates to a label to be used as a security feature with a substrate layer and with an optically changeable section which can be microstructured, wherein the optically changeable section is connected to the substrate layer. Thus, the technical problem of creating a label of the type previously mentioned which is simple, reliable, and tamper-proof is solved. The substrate layer of said label is provided with at least one recess which is arranged along a line which runs slightly below the optically changeable section. The invention also relates to a packaging, in which at least one label with a container is connected to a closure having at least one recess arranged in the area between the container and the closure.

The invention relates to a label for use as a security feature, having a substrate layer and having an optically modifiable section into which a microstructuring can be introduced, the optically modifiable section being joined to the substrate layer. The invention also relates to a pack having a container, having a closure, and having at least one such label.

Microstructurings of the type mentioned at the outset are known from the prior art and are composed of a plurality of dots and/or lines with which a surface or one or more layers of a storage medium, more particularly of a label, is modified in at least one optical property. In this context it is possible to exploit a change in reflectivity, transmittance, absorption, scattering behavior, a change in the phase of the reflected light, or a combination of all or some of these effects. The spatial resolution here may be from less than 10 μm down to dot or line dimensions of less than 1 μm. Microstructurings of this kind are used to store information; more particularly, computer-generated holograms, microimages or microtexts can be produced with them.

Computer-generated holograms are composed of one or more layers of dot matrices and/or dot distributions which, when illuminated with a preferably coherent light beam, lead to a reconstruction of the information incorporated in coded form in the hologram. The dot distribution may be calculated as an amplitude hologram, phase hologram or as a kinoform, Fresnell or Fourier hologram. For the production of computer-generated holograms, they are first calculated and then written using a suitable write device, by dotwise introduction of energy, into a storage medium, such as, for example, the optically modifiable section referred to above. As already mentioned, the resolution of the resultant dot matrix may lie within the range down to below 1 μm. Accordingly, holograms can be written with a high resolution in a narrow space. The information they contain can be read only by illumination with a light beam and reconstruction of the diffraction pattern. The size of these holograms can be between a few mm² and several cm².

A great advantage of the computer-generated holograms is that each hologram can be calculated individually without great cost and complexity. Hence it is possible to produce holograms in series which include, for example, serial numbers or production parameters. Holograms of this kind can therefore be used, in particular, as security features or in logistics for product tracking on packs, credit cards, entry cards or the like. Using a suitable read device, the security features of the hologram can be read and the authenticity and individuality of the security feature inspected in a simple way.

The above-described computer-generated holograms can be combined with directly visible information, in the form for example of a microtext and/or microimage. Besides this, using a microstructuring as mentioned at the outset, it is also possible for the aforementioned microimages and microtexts to be written in themselves, independently of computer-generated holograms. The dot distributions may also be produced in the form of dot matrix holograms, where individual small sections of area are generated each as different diffraction structures of the dot matrix hologram. Besides this it is also possible to use the microstructuring to produce a diffractive optical element (DOE) per se.

Also known from the prior art are tamperproof labels, where, for example, the first-time opening of a container, where appropriate also after any possible reclosing, is discernible from the fact that, on the first opening of the container, the label becomes modified. This modification may be a destructive tearing, supported by a suitable choice of the material of the label or by a weakening of the material. This weakening of the material may be a perforation that severs the material completely in sections. Also known are embodiments wherein multi-ply labels are used which indicate reclosing of the container, by means for example of the modification of an indicium.

A problem with the optical security features already illustrated in more detail above, and more particularly with those based on computer-generated holograms, however, is that perforations in the region of the optically modifiable section disrupt this optically modifiable section in such a way that the bulges introduced into the label by the perforation make it more difficult to reconstruct the information contained in the hologram, with the consequence that correct reading of the information is subsequently possible barely or not at all, even when the label is intact. An explanation for this is that deviations in the surface of the optically modifiable section from the mandated surface form, even in the region of several wavelengths of the radiation used to read the microstructuring, may make reconstruction impossible.

The technical problem on which the invention is based is therefore that of simply and reliably tamperproofing a label of the aforementioned kind. The technical problem also relates to a container provided with a tamperproof label as its label.

The technical problem highlighted above is solved by a label having the features of claim 1. Advantageous developments are subject matter of the dependent claims.

In accordance with the invention the substrate layer is provided with at least one recess and the at least one recess is disposed along a line which extends partly beneath the optically modifiable section. By recess in this sense is meant a measure for generating a predetermined breakage point in the label. The disposal of the at least one recess along the above-described line ensures that the label is destroyed in such a way that not only the substrate layer but also, specifically, the optically modifiable section is completely broken or torn. This ensures that any tampering damages or impairs the security-relevant feature in such a way that reading of the information it contains is no longer possible.

Accordingly an attempted tampering and/or, for example, where the label of the invention is used as a closure seal, the first-time opening of a container can be discerned beyond doubt. The label, therefore, cannot be reused.

Where, for example, a microstructuring, more particularly a computer-generated hologram, has been written in the optically modifiable section, and if this section is damaged, even only partly, then it is ensured that at least the surface form of the section is altered by the damaging in such a way that it becomes impossible to read the information stored, for example, holographically, for the simple reason of the deviation from the mandated surface form. This is so even when individual fragments of the hologram per se would still be enough for the information to be read, albeit in a poorer quality.

Where a computer-generated hologram together with a microimage and/or a microtext has been written into the optically modifiable section, the microimage or microtext may remain discernible, depending on the degree of destruction of the section, whereas the holographic structure can no longer be read.

In an advantageous way it is possible for the at least one recess to be formed as a kiss-cut which does not sever the substrate layer. The kiss-cut, then, does not completely sever the substrate layer, but weakens it to such an extent that, when the substrate layer is completely torn, the tear extends along the predetermined line. Kiss-cuts have the advantage over the perforation described below that the surface of the substrate layer is not severed and hence a desired surface form, in particular in the region of the optically modifiable section, is retained.

Accordingly it is possible, for example, for the at least one kiss-cut to extend beneath the optically modifiable section. Since the kiss-cut does not sever the optically modifiable section, its mandated surface form is retained, and so, unless the label is torn completely, it is possible to reconstruct the written information with high quality. Since, however, the kiss-cut extends beneath the optically modifiable section, in other words beneath the optically readable surface and within the substrate layer, the assurance that, when the label is completely torn, the tear will extend precisely through the optically modifiable section is particularly reliable. Nevertheless, it is necessary to ensure very precisely that, in spite of the kiss-cut, the surface of the optically readable section retains its mandated form.

An alternative possibility to the design of the recess as a kiss-cut is that the at least one recess in the substrate layer is formed as a laser cut; in other words, a laser is used to cut, or at least cut into, the substrate layer. A laser cut of this kind may be made down to a certain depth in the substrate layer or else may sever it completely in sections. Laser cutting offers the advantage that, in the course of cutting, no material is thrown up, and so the surface form of the substrate layer itself is retained when the laser cut takes place on the surface of the substrate layer. The laser cut may therefore not only extend beneath the optically modifiable section but may also run completely through the entire thickness of the substrate layer, even in the region of the microstructure. Where, for example, a hologram has been written as a microstructure into the optically modifiable region, it nevertheless remains legible, since, despite the removal of a small region of the hologram, the surface in the region of the optically modifiable section is not substantially altered.

Furthermore, the at least one recess may be formed as a perforation which at least partly severs the substrate layer. This has the advantage that, when the substrate layer is completely torn, the complete severing that is partly present as a result of the perforation already largely predetermines the lines of the tear. In this case, however, it must be ensured that the partial severing does not substantially alter the surface of the substrate layer, at least in the region of the optically modifiable section.

In the case of this design, the at least one perforation is disposed outside the optically modifiable section, and the perforation points, in its alignment, in the direction of the optically modifiable section. This ensures that the surface remains undisrupted in the region of the optically modifiable and readable section, it being possible to accept the fact that, in the region of the optically modifiable section, the tear is not 100% predetermined. The disposal described above for the perforation, outside the optically modifiable section, is also preferred for the disposal of kiss-cuts, when the substrate layer is relatively thin and when the kiss-cuts lead to an impairment in the quality of the reading of the optically modifiable section, even though the kiss-cuts do not sever the substrate layer and the optically modifiable section.

In a further-preferred way, provision may be made for two recesses to be provided which are disposed along the line on both sides of the optically modifiable section. Consequently, when the label is completely torn, the two recesses guide the tear from both sides through the optically modifiable section.

It is further preferred for a plurality of recesses to be provided which are disposed in sections along the line. By this means it is possible, particularly in the case of relatively long perforation lines or kiss-cut lines, for two or more recesses to form the line, without the substrate layer becoming weakened along the entire lines.

Furthermore, provision may be made for a plurality of recesses to be provided which are disposed on at least two different lines, at least one of the lines extending partly beneath the optically modifiable section. Hence it is possible, for example, to predetermine a line along which the label is torn through the optically modifiable section, while the label is additionally torn along another line. In one preferred embodiment, however, two or more lines are predetermined which extend through the optically modifiable section and hence ensure reliable destructive tearing of the label through the optically modifiable section, from different directions.

Another measure for ensuring the tearing of the label along a line through the optically modifiable section may be to taper the width of the substrate layer in the region of the optically modifiable section. Tapered here means that the width of the label in the plane of the optically modifiable section is lower than in the regions not occupied by the optically modifiable section. In the tapered region of the label, therefore, there is a weak point, which supports the tearing of the label in the region of the optically modifiable section along the at least one recess.

The shape of the label can of course be adapted to the particular application. Where, for example, the tamperproof label is to be provided for the closure of a container, the substrate layer can have a substantially circular section and, joined thereto, an elongate section, with the optically modifiable section being disposed in the elongate section. The substantially circular section is then mounted on the lid, while the elongate section is joined to the container. if the lid is actuated, in other words rotated or folded up or swiveled, the label is torn in the region of the elongate section, thus destroying an optically modifiable and readable section disposed at that point.

There are two possibilities for how the optically modifiable section is joined to the substrate layer. First, the optically modifiable section can be formed separately from the substrate layer. Said section is then joined cohesively or adhesively bonded to the substrate layer. Furthermore, the optically modifiable section may be formed integrally with the substrate layer, meaning that the substrate layer per se is optically modifiable overall, but the section to be modified is fixed at a specified position on the substrate layer.

The technical problem highlighted above is also solved by means of a pack, more particularly a pack for liquids, which has a container, a closure, and at least one label, and which in accordance with the invention is characterized in that the at least one label is joined to the container and to the closure and in that at least one recess is disposed in the label in the region between the container and the closure.

Hence it is ensured, in accordance with the invention, that, when the closure is opened, the label is parted along the line and the optically modifiable section is at least partly destroyed. The closure here may be a rotatable lid or a swivelable lid.

The invention is elucidated in more detail below with reference to exemplary embodiments, in respect of which reference is made to the attached drawings. In the drawings

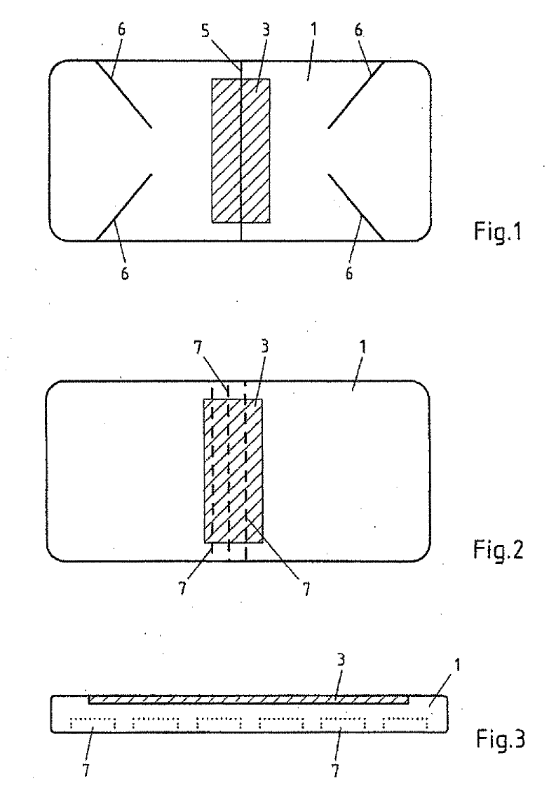

FIG. 1 shows a first exemplary embodiment of a label of the invention,

FIG. 2 shows a second exemplary embodiment of a label of the invention,

FIG. 3 shows the exemplary embodiment shown in FIG. 2, in cross section,

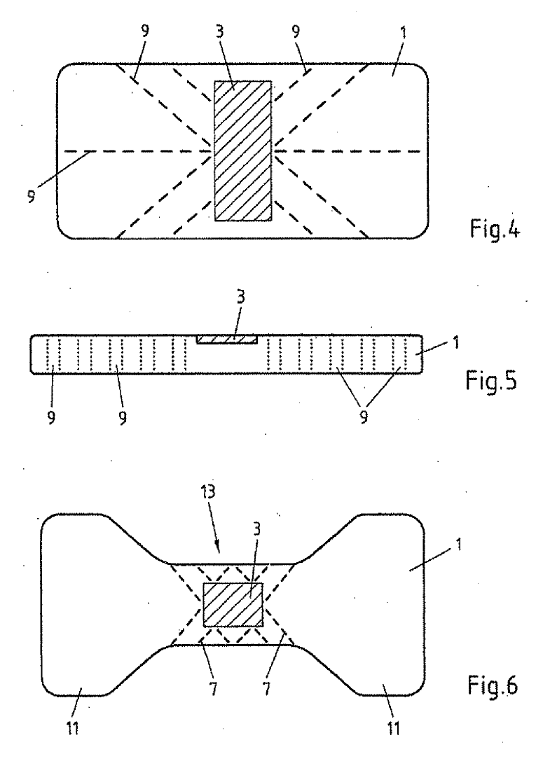

FIG. 4 shows a third exemplary embodiment of a label of the invention,

FIG. 5 shows the exemplary embodiment shown in FIG. 4, in cross section,

FIG. 6 shows a third exemplary embodiment of a label of the invention,

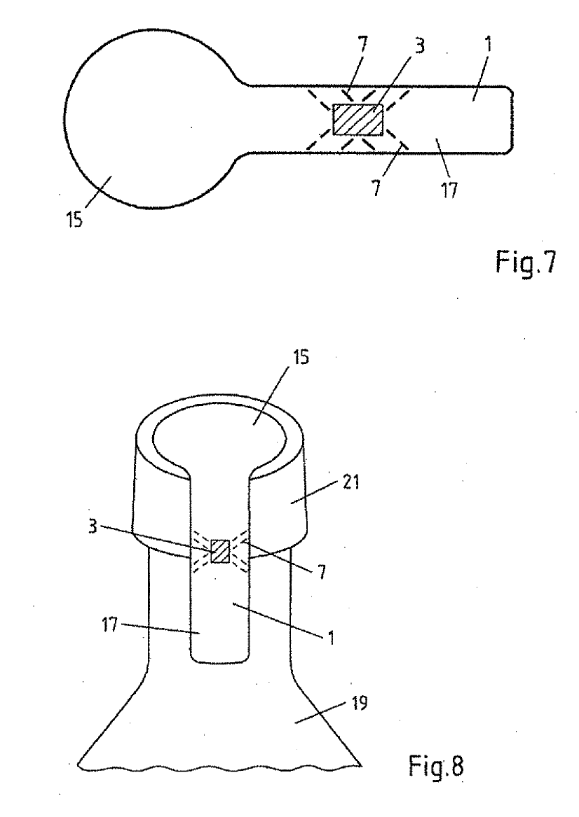

FIG. 7 shows a fourth exemplary embodiment of a label of the invention,

FIG. 8 shows the exemplary embodiment shown in FIG. 7, fastened on a screw closure of a bottle, on the one hand, and on the bottle itself, on the other hand, and

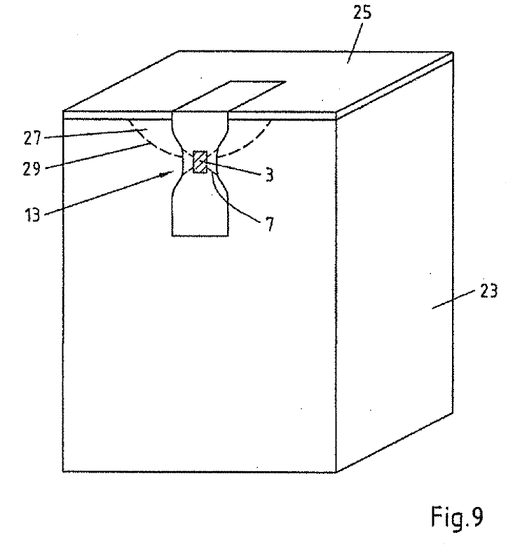

FIG. 9 shows the exemplary embodiment shown in FIG. 6, fastened to a container having a swivelable lid.

In the course of the description that is given below of the various exemplary embodiments, elements that are alike are given like reference symbols, even if they may have slightly different dimensions or designs.

FIG. 1 shows a first exemplary embodiment of a label of the invention that can be used as a security feature for packs. The label has a substrate layer 1 and, joined to it, an optically modifiable section 3 into which it is possible to write a microstructuring.

This microstructuring may be designed as a computer-generated hologram, as microtext and/or as a microimage, To write the microstructuring it is possible to use numerous write devices that are known from the prior art. Reference may be made for this purpose, by way of example, to the publications WO 02/079881, WO 02/079883, WO 02/084404, WO 02/084405, and WO 03/012549. These write devices use a laser beam which successively scans each individual dot of the dot matrix, in grid format, and which, as a function of location, introduces light energy into the label with a defined intensity. This intensity may be set so as to be dot-specific and therefore, within the region scanned in grid format, may be selected to be analog (continuously varying) or digital (on or off).

Furthermore, the substrate layer 1 has a recess 5 which is disposed along a line that extends beneath the optically modifiable section 3. In the present exemplary embodiment, the recess 5 extends right through the substrate layer 1, from the top edge, shown in FIG. 1, to the bottom edge, in other words also right through beneath the optically modifiable section 3. In this case the recess 5 does not completely sever the material of the substrate layer 1, but is instead formed, for example, as a cut which penetrates up to a maximum depth from the side of the substrate layer 1 that faces away from the optically modifiable section 3. Such a cut may be made, for example, by means of a laser, as a laser cut, in the substrate layer 1.

As well as the recess 5, a number of further recesses 6 are provided which further improve the level of tamperproofing of the label used as a security label, the additional recesses 6 effectively preventing the label from being detachable from a pack without destruction.

FIG. 2 shows an exemplary embodiment in which a plurality of relatively short kiss-cuts 7 are provided along a total of three lines disposed in parallel to one another. Since the kiss-cuts 7 are each disposed at a distance from one another along the line, in contrast to the exemplary embodiment according to FIG. 1, the impairment of the substrate layer 1 is less, and hence the surface accuracy achieved is better. As in the case of the exemplary embodiment according to FIG. 1 as well, the kiss-cuts 7 extend along the lines not only alongside but also beneath the optically modifiable section 3.

This is also discernible in the case of the cross section, shown in FIG. 3, along one of the lines of the kiss-cuts 7 through the substrate layer 1. The kiss-cuts 7 at a distance from one another are each shown by dotted lines. Here it is clear that the kiss-cuts 7 penetrate from below into the substrate layer 1, for example, only up to about half of the thickness of the layer, and so the top half of the substrate layer 1 is unimpaired. As FIG. 3 shows, the optically modifiable section 3 is disposed in the top half of the substrate layer 1, and is shown as a hatched area. The depth of the kiss-cuts 7 may vary and may also be more or less than about half of the thickness of the substrate layer 1.

FIG. 4 shows a further exemplary embodiment of a label 1 of the invention with an optically modifiable section 3 joined to it. Along a plurality of lines, perforations 9 are made in the substrate layer 1, the perforations 9 at least partly severing the substrate layer 1. As a result of this partial severing of the substrate layer 1, a very precise guide of the tear through the substrate layer 1 is achieved on tearing.

Since, however, even a partial severing of the substrate layer 1 would alter the surface of the optically modifiable section 3 to such an extent that it would be impossible to read the microstructuring made there, the perforations 9 are disposed only outside the optically modifiable section 3. Nevertheless, the lines along which the perforations 9 are disposed extend on both sides of the optically modifiable section 3 in such a way that an imaginary connecting line or alignment line extends beneath or through the optically modifiable section 3. If the label is torn along the perforations 9, then it is ensured that, in every case, the optically modifiable section 3 is altered and thus is made unusable.

As shown in FIG. 4, the perforations 9 are disposed along a total of five lines which extend at different angles in relation to the optically modifiable section 3, For each of the lines it is the case that the perforations 9 are disposed in each case on both sides of the optically modifiable section 3. In accordance with the present invention the perforation may also extend only along one of the lines drawn in FIG. 4.

FIG. 5 shows a cross section through the substrate layer 1 along the line of perforations 9 that extends horizontally in FIG. 4. Again it is possible to discern the optically modifiable section 3. The perforations 9 are represented by dotted lines, which each extend between the top side and the bottom side and thus sever the substrate layer 1 in sections.

FIG. 6 shows a further exemplary embodiment of a label of the invention having a substrate layer 1 and an optically modifiable section 3. In contrast to the exemplary embodiments described above, the substrate layer 12 has outer sections 11 with a relatively large width, between which there runs a tapered section 13. The optically modifiable section 3 and also a plurality of kiss-cuts 7 are disposed in the tapered section 13. These kiss-cuts 7 are disposed along lines, and yet the kiss-cuts 7 are located in each case only outside and not below the optically modifiable section 3.

The combination of tapered section 13 and the plurality of kiss-cuts 7 ensures in a particular way that, if the label is subjected to mechanical stress, the substrate layer 1 tears precisely in the region in which the optically modifiable section 3 is located. With this exemplary embodiment it is possible to regard as being a further advantage the fact that the outer sections 11 with relatively large width permit improved adhesive bonding of the label to the surface of an article or a pack.

FIG. 7 shows a further exemplary embodiment of a label of the invention, in which the substrate layer 1 has a substantially circular section 15 and, joined to it, an elongate section 17, the optically modifiable section 3 being disposed in the elongate section 17. Here again there are kiss-cuts 7 provided which are disposed along a plurality of lines in the substrate layer 1, the lines each being oriented such that they extend through the optically modifiable section 3.

In the exemplary embodiments elucidated above, the optically modifiable section 3 has in each case been shown as a separate section within the substrate layer 1. The primary purpose of this depiction is to illustrate the arrangement of the optically modifiable section 3 within the substrate layer 1. On the one hand, the optically modifiable section 3 may be manufactured from a material which is different than the material of the substrate layer 1. On the other hand, the optically modifiable section 3 may be manufactured from the same material as the substrate layer 1, and so the optically modifiable section 3 is formed integrally with the substrate layer 1.

FIG. 8 shows an application of a label of the invention, as depicted in FIG. 7, as a security feature for a pack.

In the present exemplary embodiment, the pack is in the form of a bottle 19 which is closed with a rotatable closure 21. The label 1 shown in FIG. 7 is joined both to the bottle 19 and to the closure 21. For that purpose, the substantially circular section 15 and a bordering part of the elongate section 17 are joined to the closure 21, while the other part of the elongate section 17 is joined to the bottle 19.

As FIG. 8 additionally shows, the kiss-cuts 7 are disposed in the region between the bottle 19 and the closure 21, and so, when the closure 21 is opened, the label is separated along at least one line of the kiss-cuts 7, and the optically modifiable section 3 is at least partly destroyed. The complete tearing of the label therefore takes place, when the closure 21 is opened, as a result of the associated rotational movement relative to the bottle 19, with a consequence that the shearing forces which come about during the rotational movement cause the tearing of the substrate layer 1 and hence the destruction of the optically modifiable section 3.

FIG. 9 shows a further example of a pack which in the present case takes the form of a cardboard pack 23 having a swivelable lid 25. To open the pack it is first necessary to press in an opening section 27 with the aid of a perforation 29, before the swivelable lid 25 can be raised. A label which corresponds essentially to the exemplary embodiment depicted in FIG. 6 is joined both to the cardboard pack 23 and to the lid 25. In this case the tapered section 13 is disposed in the region of the perforation 29, and so not only the optically modifiable section 3 but also the kiss-cuts 7 are disposed at the point where it is necessary to press in the opening section 27 in order to open the pack. The kiss-cuts 7 then ensure that not only the substrate layer 1 but also the optically modifiable section 3 and hence the security feature of a microstructuring are destroyed when the pack 23 is opened.

1-11. (canceled)

12. A label for a security feature comprising
a substrate layer (1) with an optically modifiable section (3) capable of accepting a micro-structuring, the optically modifiable section (3) being joined to the substrate layer (1),
wherein the substrate layer (1) includes at least one recess (5, 7, 9), and wherein the at least one recess (5, 7, 9) is disposed linearly and partly beneath the optically modifiable section (3).

13. The label of claim 12, wherein the at least one recess is formed as a kiss-cut which does not sever the substrate layer (1).

14. The label of claim 12, wherein the at least one recess is formed as a laser cut.

15. The label of claim 12, wherein the at least one recess is formed as a perforation which at least partly severs the substrate layer (1).

16. The label of claim 12, wherein the at least one recess (5, 7, 9) is disposed outside the optically modifiable section (3).

17. The label of claim 12, wherein two recesses are provided which are disposed along the line on both sides of the optically modifiable section (3).

18. The label of claim 12, wherein a plurality of recesses are provided which are disposed on at least two different lines, at least one of the lines extending partly beneath the optically modifiable section (3).

19. The label of claim 12, wherein the substrate layer (1) has a tapered section (13) near the optically modifiable section (3), the optically modifiable section (3) being disposed in the elongate section (17).

20. The label of claim 12, wherein the optically modifiable section (3) is formed separately from the substrate layer (1).

21. A packaging for liquids, comprising
a container (19, 23) including a closure (21, 25), and having at least one label according to claim 1,
wherein the at least one label is joined to the container (19, 23) and to the closure (21, 25) and the at least one recess (5, 7, 9) is disposed in the label between the container (19, 23) and the closure (21, 25).

22. The packaging of claim 21, wherein the closure is a rotatable lid (21) or a swivelable lid (25).

23. The label of claim 12, wherein the at least one recess is formed as a kiss-cut which does not sever the substrate layer (1), and wherein the at least one kiss-cut (5, 7) extends beneath the optically modifiable section (3).

24. The label of claim 12, wherein a plurality of recesses (7, 9) are provided which are arranged sections disposed linearly.

25. The label of claim 12, wherein the substrate layer (1) has a tapered section (13) near the optically modifiable section (3) and wherein the substrate layer (1) has a substantially circular section (15) and an elongate section (17) joined thereto, the optically modifiable section (3) being disposed in the elongate section (17).

26. The label of claim 12, wherein the optically modifiable section (3) is formed integrally with the substrate layer (1).
